(19) United States
(12) Patent Application Publication
(10) Pub. No.: US 2015/0100694 A1
(43) Pub. Date: Apr. 9, 2015

(54) USE OF ITERATIVE LEARNING FOR RESOLVING SCALABILITY ISSUES OF BANDWIDTH BROKER

(71) Applicant: Shaleeza Sohail, Jeddah (SA)

(72) Inventor: Shaleeza Sohail, Jeddah (SA)

(73) Assignee: UMM AL-QURA UNIVERSITY, Makkah (SA)

(21) Appl. No.: 14/046,096

(22) Filed: Oct. 4, 2013

(51) Int. Cl. H04L 12/911

(52) U.S. Cl. CPC H04L 47/70
USPC 709/226

(57) ABSTRACT

A centralized bandwidth broker (a special network server) functioning as a domain manager in an internet network having differentiated services architecture is responsible for receiving and replying to a large number of requests and for performing huge numbers of resource management tasks at the inter- and intra-domain level. Consequently, it can have scalability issues. According to the invention the bandwidth broker maintains an experience database in addition to information about other aspects of the network, and uses iterative learning for solving scalability issues by using information of previous good experiences to take future resource management decisions. Based on similarity with previous network and request conditions, the new decision can be taken without executing resource intensive algorithms. The database of experience is continuously updated for optimized iterative learning. Processing overhead is reduced, enabling a single bandwidth broker to manage big networks with large numbers of users.

### FIELD OF THE INVENTION

This invention relates generally to a method for resolving scalability issues of a bandwidth broker in the transfer of information on the internet. More particularly, the invention relates to a method for resolving scalability issues and providing end-to-end Quality of Service (QoS) in an internet network with Differentiated Services architecture (DiffServ), wherein a centralized bandwidth broker uses iterative learning to perform dynamic admission control, resource allocation, and policy-based management of the network by relying on knowledge from prior decision making to achieve optimal, quick and effective decision making under current network conditions.

### BACKGROUND OF THE INVENTION

Since the mid-1990s, the Internet has had a revolutionary impact on culture and commerce, including the rise of near-instant communication by electronic mail, instant messaging, Voice over Internet Protocol (VoIP) “phone calls”, two-way interactive video calls, and the World Wide Web with its discussion forums, blogs, social networking, and online shopping sites

Early systems required a user to switch from one terminal to another, each with a different set of commands, in order to communicate with different remote terminals. Packet switching was developed for connecting separate physical networks to form one logical network, thus avoiding the waste of resources that occurred in these very early systems. In packet switching, messages are divided into suitably sized arbitrary blocks or packets in which all transmitted data is grouped—regardless of content, type, or structure—with routing decisions made per-packet. Packet Switching is a rapid store-and-forward networking design that features delivery of variable-bit-rate data streams (sequences of packets) over a shared network. When traversing network adapters, switches, routers and other network nodes, packets are buffered and queued, resulting in variable delay and throughput depending on the traffic load in the network.

Packet mode communication may be utilized with or without intermediate forwarding nodes (packet switches or routers). In all packet mode communication, network resources are managed by statistical multiplexing or dynamic bandwidth allocation in which a communication channel is effectively divided into an arbitrary number of logical variable-bit-rate channels or data streams. Statistical multiplexing, packet switching and other store-and-forward buffering introduce varying latency and throughput in the transmission. Each logical stream consists of a sequence of packets, which normally are forwarded asynchronously by the multiplexers and intermediate network nodes using first-in, first-out buffering. Alternatively, the packets may be forwarded according to some scheduling discipline for fair queuing, traffic shaping, differentiated or guaranteed Quality of Service (QoS), or for Best Effort.

Best effort internet networks can only guarantee that the network will do its best to take the data traffic to its destination. Hence, Quality of Service (QoS), which is the ability of any network to make sure that the data definitely reaches its destination within a predefined time span cannot be supported on best effort internet networks. Therefore, the Internet Engineering Task Force (IETF) has proposed a number of architectures to enable service provisions to data traffic in the network in order to assure QoS. One such effort is the Differentiated Services (DiffServ) architecture which divides traffic into classes and routers and treats those classes according to their preconfigured and predefined priority. Published US patent application 2011/0069768 is exemplary of such a system.

In the IETF Differentiated Services (DifIServ) framework, a centralized bandwidth broker that keeps a comprehensive database of the network is a logical resource manager to dynamically perform admission control, resource allocation, and policy based management of the network for the control and management of QoS provisioning and to reduce the complexity of QoS control plane. Under this centralized model, each network domain has a bandwidth broker (a special network server) that is responsible for maintaining the network QoS states and performing various QoS control and management functions such as admission control, resource reservation and provisioning for the entire network domain.

A bandwidth broker is a complex logical entity that needs to perform multiple tasks at two levels: (a) inter-domain level, to streamline management tasks between different domains; and (b) intra-domain level, for optimal allocation and efficient utilization of the network resources within its domain. A number of techniques have been proposed for the bandwidth broker to perform effective resource allocation, admission control, dynamic management, scalable architectural design and so on. The system disclosed in published US patent application number 2011/0158095 is exemplary of such a technique. However, as discussed in U.S. Pat. No. 7,257,632, the centralized bandwidth broker model for QoS control and management introduces its own scalability issues, in particular, the ability of the bandwidth broker to handle large volumes of flows as the network system scales. Under heavy request load the bandwidth broker itself can become the bottleneck for the process of proper and dynamic resource allocation. In such conditions the bandwidth broker may not be able to adequately perform resource allocation and admission control even when resources are available in the network.

The scalability problems of a bandwidth broker have been an active area of research and a number of patents have proposed solutions for these issues. The related prior art can be classified into two overlapping categories:
(a) The first category consists of techniques that propose a delegation mechanism wherein the admission control task is partially delegated to edge routers.
(b) The second category consists of techniques that propose distributed architecture for the bandwidth broker.

It is important to point out that there are a number of similarities between the techniques of the two categories. For example, the techniques of the first category propose the use of edge routers for partially performing admission control decisions. The functions allocated to these edge routers are very similar to those allocated to edge/secondary bandwidth brokers by the techniques of the second category.

The current invention is different from any previous work as it uses previous experiences to make current resource allocation decisions, thereby reducing the processing burden on the bandwidth broker in order to make it more scalable.

Exemplary of some previous patents belonging to the above-mentioned two categories are: U.S. Pat. No. 8,208,374 to Brandt et al; U.S. Pat. No. 7,652,989 to Yang et al; published US patent application number 2004/0081092 to Rhee et al; and published US patent application number 2003/0028641 to Zhang et al.

Brandt et al. discloses a delegating technique to reduce the load on the bandwidth broker. The inventors assert that only the requests for the resources in bandwidth critical area need to be sent to the bandwidth broker and other tasks are handled locally.

Rhee et al. also disclose a delegation technique, wherein the path level admission control decisions are taken by the edge routers, which have some bandwidth to use for local admission control. The bandwidth broker is responsible for link level admission control by using a measurement based method.

Following a similar trend, Yang et al. discloses an adaptive method to make ingress nodes responsible for some portion of the bandwidth for performing admission control. The bandwidth broker only needs to be contacted for resources when ingress nodes did not have enough resources to fulfill any request.

As previously noted, the techniques claimed in the aforementioned patents belonging to the second category propose using multiple distributed bandwidth brokers in a single domain to handle all management tasks. Zhang el al. discloses the use of one central and multiple edge bandwidth brokers for solving the scalability problems. The edge bandwidth brokers have responsibility of path level resource allocation for the pre-assigned resources. The central bandwidth broker has responsibility for link level bandwidth allocation mechanism and for allocating resources to edge bandwidth brokers.

In a DiffServ network where only slow time scale, static resource provisioning and traffic engineering are performed, for example, to set up virtual private networks, the scalability problem may not be acute. But with the rapid evolution of today's Internet, many new applications and services such as Voice over IP (VoIP), on-demand media streaming and real-time content delivery (e.g., stock quotes and news) may require dynamic QoS control and management such as admission control and resource provisioning at the time scale of flow arrival and departure. In these circumstances, an improperly-designed centralized bandwidth broker system can become a potential bottleneck, limiting the number of flows that can be accommodated into the network system while the network system itself is still under-loaded. Two major limiting factors are: (1) the memory and disk access speed; and (2) communication capacity between the bandwidth broker and edge routers. Published US patent application 2002/0087699 is exemplary of a system for obtaining dynamic QoS management in a differentiated services network using bandwidth brokers.

### BRIEF SUMMARY OF THE INVENTION

An important aspect that can improve optimal, quick and effective decision making by a bandwidth broker is to incorporate iterative learning in its decision making. Learning from past experiences and using that knowledge for reducing the overhead of the management decisions can solve scalability issues related to the bandwidth broker. Applicant proposes the use of Case Based Reasoning (CBR) by the bandwidth broker to reuse past existing solutions based on the similarity with the present network conditions in order to reduce computational and time overhead for resource management and admission control decisions. It is important to point out that to support such learning, in addition to other network related information the bandwidth broker also keeps a database of its past decisions to support continuous learning.

As conventionally practiced and in accordance with the invention the bandwidth broker contains a comprehensive network-related database which enables it to have complete knowledge of the resource and policy conditions of the network. Published US patent application 2007/0098015 relates to such a system. In addition, the current invention proposes that in that database, the bandwidth broker also keeps information about its past decisions and experiences in the form of <Request Parameters (RP), Network Conditions (NC), Bandwidth Broker Decision (BBD), and Satisfaction Index (SI)>. Request parameters are the parameters related to the request, like requested resources and relevant SLAs, etc. Network conditions contains information about the network conditions at the time of the request, like resource utilization and allocation. Bandwidth broker decision points to the decision made by the bandwidth broker based on the request parameters and network conditions at the time of the request. Satisfaction index is the parameter which shows the result/effect/outcome of the decision. This parameter is introduced to record the effect of the bandwidth broker's decision on the network, its traffic and its users. The satisfaction index parameter can be used according to the need of the network and can be decided by the network administrator.

Two methods applied by applicant for using the satisfaction index in order to improve users' satisfaction and network resource usage, respectively, are:
(a) Incorporating Quality of Experience (QoE) in the bandwidth broker's decision making process. QoE is the users' satisfaction for the network service received by its resource request. This could be used as a satisfaction index (for example 1 being very bad—10 being highly satisfied)
(b) Using resource utilization in terms of admitted calls (1 being poorly utilized—10 being optimally utilized).

In short, any type of feedback that is most important for proper and effective working of the network can be used for calculating the satisfaction index.

For admission control, on receiving a resource request the bandwidth broker checks relevant resource availability and policy conditions and allocates the resources accordingly. A number of admission control and resource management techniques have been proposed for this method. Applicant proposes that before executing a resource allocation algorithm to find the reply for resource allocation request, the bandwidth broker checks its past experiences database to find a record in the past experience database that is most similar to the present request parameters and network conditions. If the satisfaction index for that record is high, the same decision is taken. In case the satisfaction index is low or no similar record can be found, the bandwidth broker executes the resource allocation algorithm. Hence, the number of executions of the resource allocation algorithm required to find an appropriate response for the resource request is reduced.

At the completion of the request the satisfaction index is received from the user or the network administrator for that record instance and is kept in the experience database. An important aspect to consider is that only the record of the most recent decisions are kept as those are more relevant for decision making purposes. Continuous update of the experience database in this way supports nonstop and iterative learning.

The invention also comprises a system for resolving scalability issues in an internet network wherein a centralized bandwidth broker performs dynamic admission control, resource allocation, and policy-based management of the network by relying on knowledge from prior decision making to achieve optimal, quick and effective decision making under current network conditions, comprising:

a centralized bandwidth broker that contains a network-related comprehensive database of the resource and policy conditions of the network, and an experience database of information about prior decisions and experiences of the bandwidth broker in the form of request parameters, relevant service level agreements, information about the network conditions at the time of the request, and satisfaction index for previously allocated network services, said bandwidth broker causing the system to:
receive a resource allocation request from a requesting entity;
check in the experience database for a record of a similar resource allocation request and the decision made in response thereto;
make the same decision for resource allocation under present network conditions as the prior decision if the record of a prior similar request exists and the satisfaction index is high, or execute a resource allocation algorithm if there is no record of a prior similar allocation request or if there is a record of a prior similar request but the satisfaction index is low; and
send a resource allocation reply to the requesting entity.

### BRIEF DESCRIPTION OF THE DRAWINGS

The foregoing, as well as other objects and advantages of the invention, will become apparent from the following detailed description when taken in conjunction with the accompanying drawings, wherein like reference characters designate like parts throughout the several views, and wherein:

FIG. 1 is a schematic diagram showing the details of the communication of a bandwidth broker (BB) with other entities in a DiffServ domain.

FIG. 2 is a flow chart showing the use of existing decisions to minimize the number of executions of the resource allocation algorithm, which results in scalable design of a bandwidth broker.

FIG. 3 is a table showing the mechanism of collecting satisfaction index values from users or a network administrator for requests completed by the bandwidth broker.

FIG. 4 is a flow chart showing the iterative update of the experience database in order to maintain only the most recent satisfaction index values of similar decisions in order to use only the recent values for decision making purposes.

### DESCRIPTION OF THE PREFERRED EMBODIMENTS OF THE INVENTION

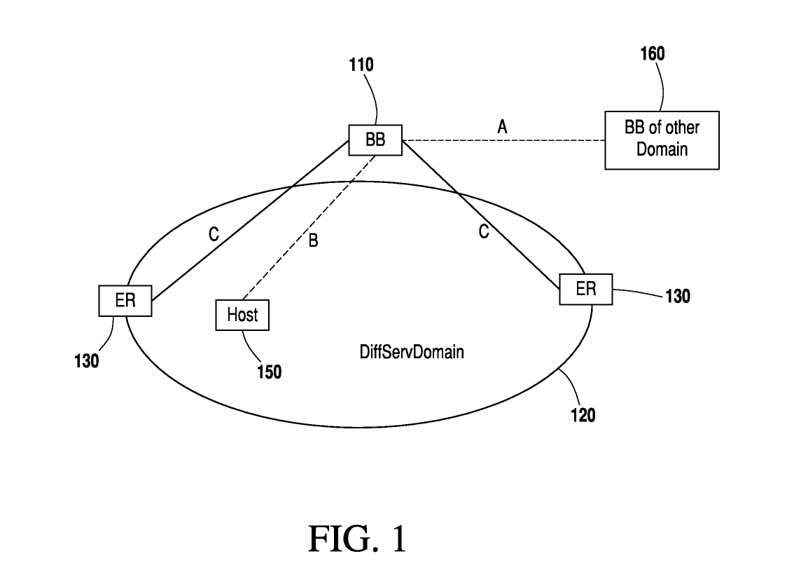

FIG. 1 shows the working of bandwidth broker 110 in a differentiated services domain 120. The bandwidth broker 110 is a logical entity; hence, it can physically be placed at any edge or core router and during network configuration routers are informed about the bandwidth broker's address. The bandwidth broker 110 receives resource requests from local domain users like host 150 and also from the bandwidth broker of other domains such as shown at 160. These resource requests/response communications from host 150 and domain 160 to bandwidth broker 110 are shown as B and A respectively. After receiving the request, bandwidth broker 110 replies to the requesting entity.

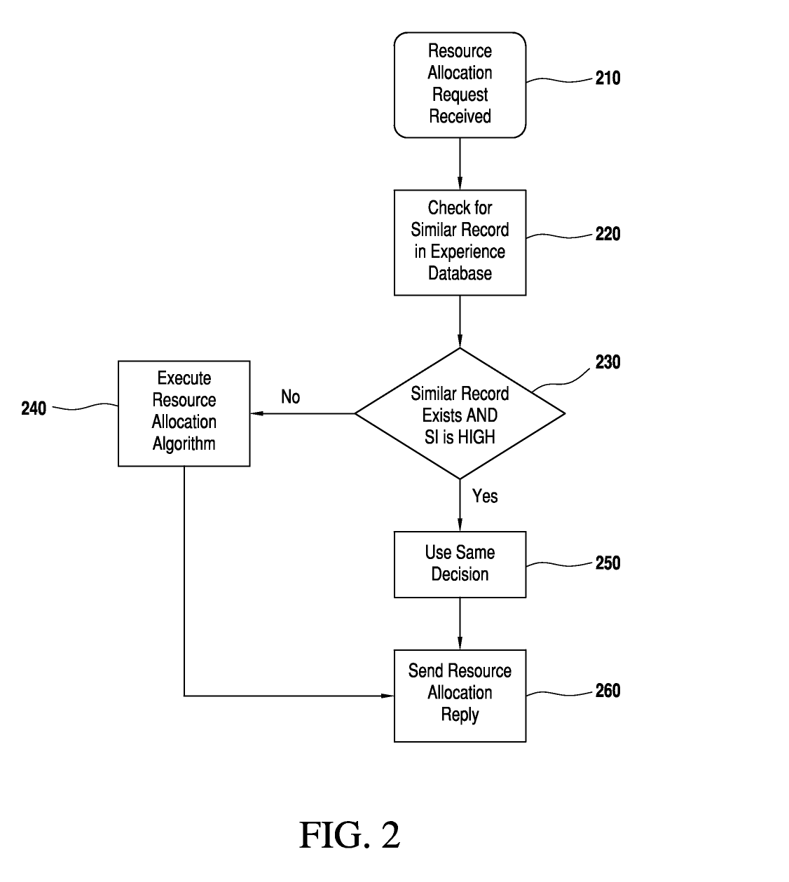

FIG. 2 shows the process involved according to the present invention when bandwidth broker 110 receives a resource request sent by local host 150 or bandwidth broker 160 of another domain. Bandwidth broker 110 and edge routers 130 communicate with each other for exchange of configuration information as shown at C. The bandwidth broker 110 receives a bandwidth allocation request 210 and the first step 220 is to search the experience database for a similar record. Two aspects are checked simultaneously at step 230 that such record exists and what is the satisfaction index for that record. If a similar record with a high satisfaction index exists then the decision similar to that record is taken at 250. In case there is no similar record or if the satisfaction index of the existing similar record is low then the resource allocation algorithm executes at 240 and finds the decision for the current resource request. In either case, the resource allocation reply is sent to the requesting entity at 260.

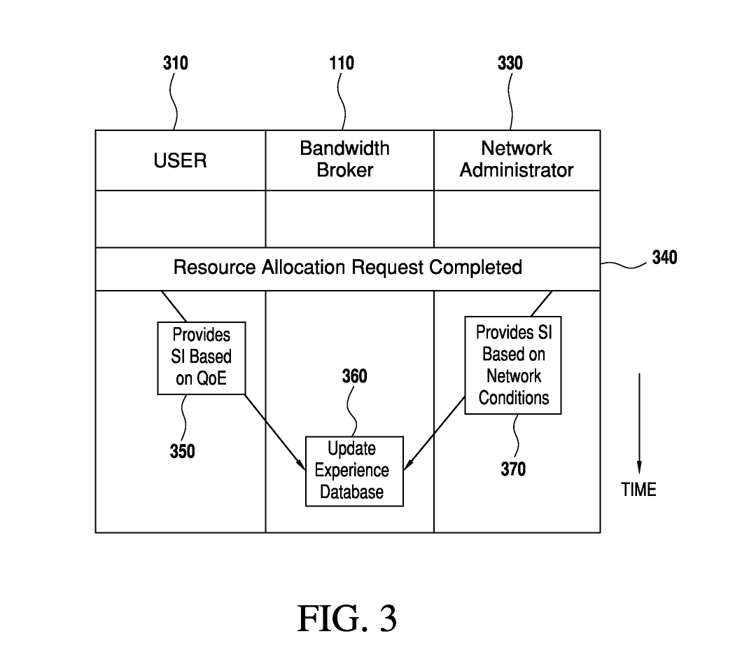

FIG. 3 shows the timeline for the process of collecting a satisfaction index value for update of the experience database by bandwidth broker 110 after resource allocation request completes at 340. All other parameters for the record update are already known by the bandwidth broker 110 and only the satisfaction index value is required. The satisfaction index value can be based on any parameter most important for the network. Applicant discusses herein only two options for getting the satisfaction index value.

According to one option the network administrator 330 provides a satisfaction index value based on network conditions during the time the requested resources were allocated at 370, which indicates the overall network conditions such as congestion, packet drop rate, etc., while the resources were allocated for that particular request.

According to another option, the resource user 310 provides a satisfaction index value based on its Quality of Experience at 350, which indicates users' satisfaction by the services received by the network.

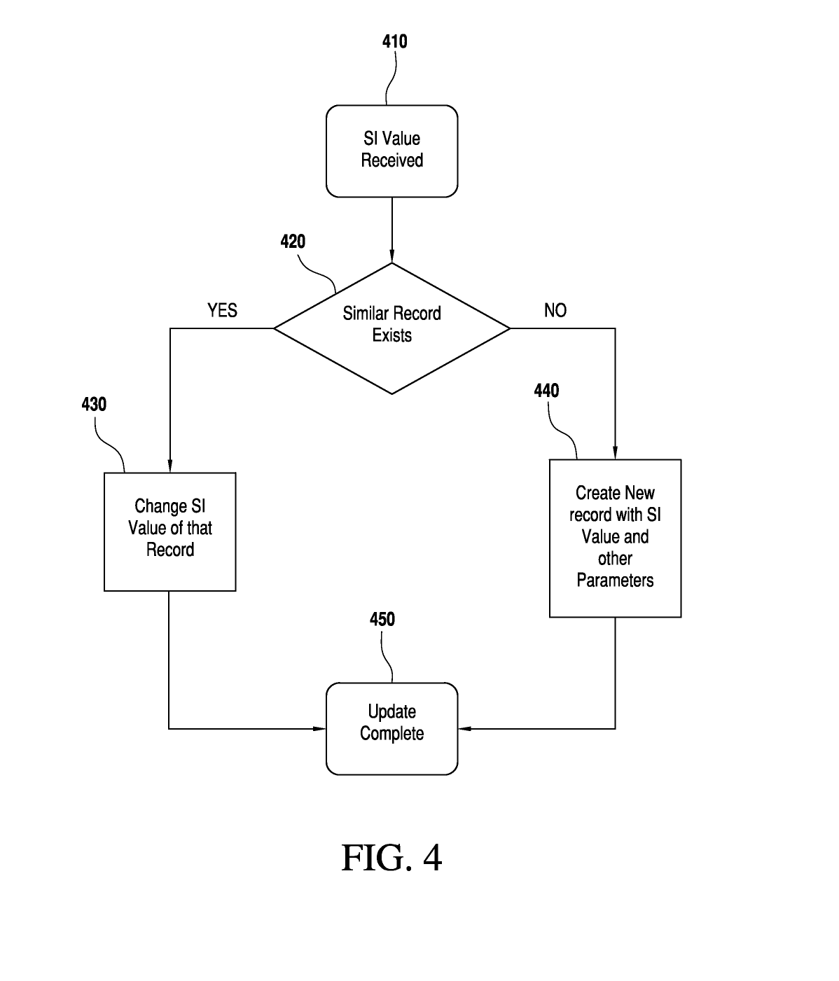

FIG. 4 is a flow chart showing details of the update procedure 360 for experience database by the bandwidth broker 110. On receiving the satisfaction index value from the user 310 or network administrator 330 the bandwidth broker 110 checks if a similar record exists in the experience database as 420. If such record exists then the satisfaction index value of that record is updated as 430. If no such record exists then a new record is created with that satisfaction index value in the experience database as 440. Completion of update of the experience database is shown at 450. Such updates are iterative, as the satisfaction index value of the similar existing records is updated after completion of current requests, whereby the satisfaction index value always shows the most recent input by the user 310 or network administrator 330. The experience database learns from the most recent experience; hence, the resource allocation decisions stored in the experience database are always up to date.

The aim of the present invention is to use iterative learning for resolving scalability issues encountered by bandwidth brokers performing dynamic admission control, resource allocation, and policy-based management of internet networks.
Use of satisfaction index allows a network administrator to effectively base decisions on information which is most crucial for commercial use, like Quality of Experience of the user or resource utilization of the network.
Continuous learning allows use of past information for repeating the good decisions and avoiding bad decisions for admission control with most recent values kept in the database.
As the database of experience develops with time, the average number of times that the admission control algorithm needs to be executed reduces, which minimizes computational overhead and results in quick response time for users.

The scalability issues of the bandwidth broker can be resolved as a single central entity that can handle a large number of users' requests without being overburdened.

While the invention has been described in connection with its preferred embodiments, it should be recognized that changes and modifications may be made therein without departing from the scope of the claims.

What is claimed is:

1. A method for resolving scalability issues of a bandwidth broker functioning as a domain manager in an internet network, wherein a centralized bandwidth broker keeps an experience database of prior decisions and uses iterative learning to perform dynamic admission control, resource allocation, and policy-based management of the network by relying on knowledge from prior decision making to achieve optimal, quick and effective decision making under current network conditions.

2. The method claimed in claim 1, wherein:
a network architecture is selected to obtain end-to-end Quality of Service.

3. The method of claim 2, wherein:
the network architecture selected is Differentiated Services architecture.

4. The method of claim 3, wherein:
in addition to the database of prior decision making kept by the bandwidth broker, the bandwidth broker keeps a comprehensive network-related database of the resource and policy conditions of the network to enable it to perform dynamic admission control, resource allocation, and policy based management of the network.

5. The method of claim 4, wherein:
the bandwidth broker searches the experience database of prior decision making for a record similar to current network conditions and if a similar record with a high satisfaction index exists then the bandwidth broker takes a decision similar to the decision taken in that record to allocate resources for the current network conditions.

6. The method of claim 5, wherein:
if there is no similar record or if the satisfaction index of the existing similar record is low then a resource allocation algorithm is executed to find an appropriate decision for the current resource request.

7. The method of claim 6, wherein:
the database of prior experience is continuously updated for optimized iterative learning and up to date data collection.

8. A method for resolving scalability issues of a centralized bandwidth broker functioning as a domain manager in an internet network wherein the bandwidth broker assigns network resources to an entity requesting resource allocation, comprising:
maintaining a comprehensive network-related database of the resource and policy conditions of the network;
maintaining an experience database of information about prior decisions and experiences of the bandwidth broker in the form of request parameters related to a request made by a requesting entity for resource allocation, said request parameters including requested resources and relevant service level agreements, information about the network conditions at the time of the request like resource utilization and allocation, and satisfaction index for previously allocated network services; and
making a decision for resource allocation based on a prior decision made by the bandwidth broker for similar request parameters and network conditions and applying it to current network conditions when the prior decision had a high satisfaction index.

9. The method of claim 8, wherein:
if there is no similar record or if the satisfaction index of the existing similar record is low then a resource allocation algorithm is executed to find an appropriate decision for the current resource request.

10. The method of claim 9, wherein:
the database of prior experience is continuously updated for optimized iterative learning and up to date data collection.

11. The method of claim 10, wherein:
the internet network has Differentiated Services architecture and achieves end-to-end Quality of Service.

12. The method of claim 8, wherein:
the requesting entity provides to the bandwidth broker a satisfaction index based on quality of service.

13. The method of claim 12, wherein:
when a similar record exists, the satisfaction index value of that record is changed to the satisfaction index value for the current resource allocation request; and
if no similar record exists, a new record with a new satisfaction index value and other parameters is created, thus updating the experience database.

14. A system for resolving scalability issues in an internet network wherein a centralized bandwidth broker performs dynamic admission control, resource allocation, and policy-based management of the network by relying on knowledge from prior decision making to achieve optimal, quick and effective decision making under current network conditions, comprising:
a centralized bandwidth broker that contains a network-related comprehensive database of the resource and policy conditions of the network, and an experience database of information about prior decisions and experiences of the bandwidth broker in the form of request parameters, relevant service level agreements, information about the network conditions at the time of the request, and satisfaction index for previously allocated network services, said bandwidth broker causing the system to:
receive a resource allocation request from a requesting entity;
check in the experience database for a record of a similar resource allocation request and the decision made in response thereto;
make the same decision for resource allocation under present network conditions as the prior decision if the record of a prior similar request exists and the satisfaction index is high, or execute a resource allocation algorithm if there is no record of a prior similar allocation request or if there is a record of a prior similar request but the satisfaction index is low; and
send a resource allocation reply to the requesting entity.

15. The system of claim 14, wherein:
the internet network has differentiated services architecture.

16. The system of claim 15, wherein:
the system provides end-to-end quality of service.

17. The system of claim 16, wherein:
the requesting entity provides to the bandwidth broker a satisfaction index based on quality of service.

18. The system of claim 17, wherein:
the system includes a network administrator and the network administrator provides to the bandwidth broker a satisfaction index based on network conditions.
